(19) United States
(12) Patent Application Publication
(10) Pub. No.: US 2012/0194699 A1
(43) Pub. Date: Aug. 2, 2012

(54) ILLUMINATION DEVICE, IMAGING DEVICE, AND IMAGING SYSTEM

(75) Inventor: Yousuke KOUNO, Yokohama-shi (JP)

(73) Assignee: NIKON CORPORATION, Tokyo (JP)

(21) Appl. No.: 13/401,018

(22) Filed: Feb. 21, 2012

Related U.S. Application Data
(63) Continuation of application No. 11/886,769, filed on Sep. 20, 2007, now abandoned.

(30) Foreign Application Priority Data
Mar. 25, 2005 (JP) 2005-088213

(51) Int. Cl. H04N 5/235

(52) U.S. Cl. 348/229.1; 348/E05.037

(57) ABSTRACT

An illumination device performs illumination light communication, and signals indicative of the luminance of an object illuminated with illumination light and the color temperature of the illumination light are superposed on the illumination light. An electronic camera demodulates the illumination light received by a light-receiving circuit and determines the aperture value and the shutter value depending on luminance information included in the demodulation signal and an imaging sensitivity set in the electronic camera. The electronic camera demodulates the illumination light received by the light-receiving circuit and changes the color temperature adjustment reference used for color adjustment processing in accordance with color temperature information.

This is a Continuation of application Ser. No. 11/886,769 filed Sep. 20, 2007, which in turn is a National Phase of International Application No. PCT/JP2006/303423 filed Feb. 24, 2006, which claims the benefit Japanese Patent Application No. 2005-088213 filed Mar. 25, 2005. The disclosures of the prior applications are hereby incorporated by reference herein in their entirety.

### TECHNICAL FIELD

The present invention relates to an imaging system using illumination light communication.

### BACKGROUND ART

Patent Document 1 discloses a technology that involves controlling a light emission quantity of an LED used for display on an electronic device to thereby superpose a signal on display light. Non-patent Document 1 discloses a technology for superposing a signal on illumination light by controlling a light emission quantity of an illumination device constituted by LEDs.

Patent Document 1: Japanese Laid-Open Patent Publication No. 2004-248128

Non-Patent Document 1: Komine, Tanaka, and Nakagawa, “Merged System for White LED Illumination Signals and Power Line Signals”, the Institute of Electronics, Information and Communication Engineers (IEICE), Technical Research Paper, Vol. 101, No. 726, pp 99-104, Mar. 12, 2002.

### DISCLOSURE OF THE INVENTION

### Problem to be Solved by the Invention

When an object illuminated by an illuminator is photographed by an electronic camera, users may wish to change imaging conditions of the electronic camera (for example, shutter speed and aperture value, as well as white balance setting) depending on conditions of illumination light (for example, luminance and color temperature). On this occasion, what is required on the camera side is to measure conditions of illumination light and to input information on changes to be made into the camera.

In addition, users may wish to store photographic information (for example, explanation on a photographed scene) along with a captured image in the electronic camera used. On this occasion, an operation for inputting information such as voice memorandum into the camera is necessary.

### Means for Solving the Problem

According to a first aspect of the present invention, an illumination device includes: a light emitter that emits illumination light; a modulating unit that causes the light emitter to emit the illumination light in a modulated state; and a modulation controlling unit that controls the modulating unit to superpose on the illumination light a signal to be used in an imaging device that captures an image of an object illuminated with the illumination light.

According to a second aspect of the present invention, in the illumination device according to the first aspect, it is preferable that the signal to be used in the imaging device includes at least one of information used for changing imaging conditions of the imaging device and information for explaining an imaging scene of the imaging device.

According to a third aspect of the present invention, an imaging device includes: a light-receiving element that receives illumination light on which a signal is superposed; a demodulating unit that demodulates a light signal received at the light-receiving element; an imaging condition changing unit that changes an imaging condition using information contained in the signal demodulated by the demodulating unit; and an imaging unit that performs imaging under the imaging condition thus changed.

According to a fourth aspect of the present invention, in the imaging device according to the third aspect, the imaging condition includes at lease one of aperture value, shutter speed, and color temperature reference.

According to a fifth aspect of the present invention, an imaging device includes: a light-receiving unit that receives illumination light on which a signal is superposed; a demodulating unit that demodulates a light signal received a the light-receiving unit; and an information recording unit that records information contained in the signal demodulated by the demodulating unit into a recording medium.

According to a sixth aspect of the present invention, the imaging device according to the fifth aspect may further include an image-capturing device that captures an image of an object to obtain an electronic image, and it is preferable that the signal demodulated by the demodulating unit contains information explaining an imaging scene, and the information recording unit records the information explaining the imaging scene together with the electronic image into the recording medium.

According to a seventh aspect of the present invention, an imaging system includes: the illumination device according to the first of second aspect; and the imaging device according to any one of the third to sixth aspects.

### ADVANTAGEOUS EFFECT OF THE INVENTION

According to the present invention, signals used in an imaging device are superposed on illumination light of an illumination device, so that the signals can be directly transmitted to the imaging device.

In addition, according to another aspect of the present invention, imaging conditions are changed by using information carried on signals superposed on the illuminate light, so that an operation of inputting the information on changes may become unnecessary.

Further, according to still another aspect of the present invention, storing the information carried on signals superposed on the illumination light in a recording medium makes unnecessary the operation of inputting recording information into the imaging device.

### BRIEF DESCRIPTION OF THE DRAWINGS

FIG. 1 is a diagram illustrating an imaging system according to a first embodiment of the present invention;

FIG. 2 is a block diagram illustrating the configuration of an illumination device;

FIG. 3 is a block diagram illustrating the configuration of an electronic camera; and

FIG. 4 is diagram illustrating an illumination device according to a second embodiment of the present invention.

### BEST MODE FOR CARRYING OUT THE INVENTION

Hereinafter, the best mode for carrying out the present invention is explained.

### First Embodiment

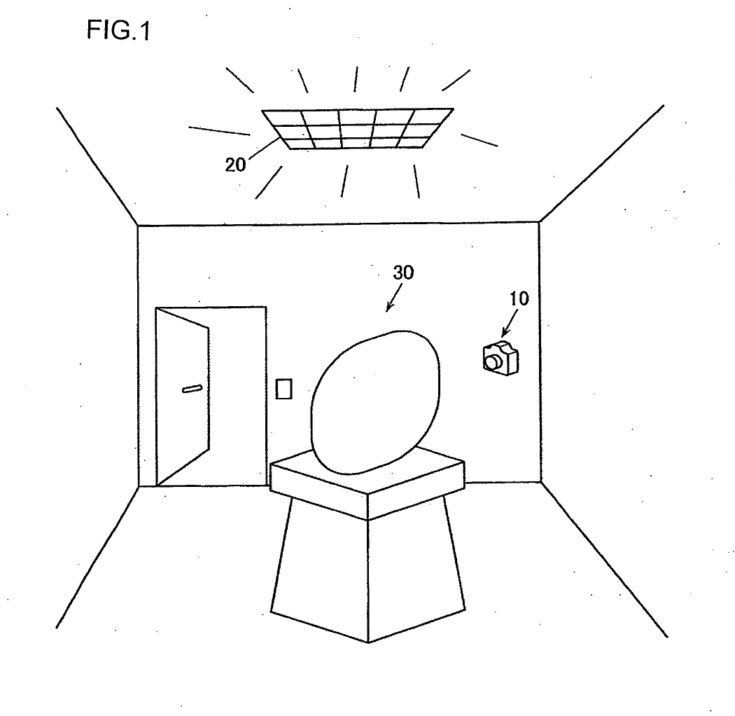

FIG. 1 is a diagram illustrating an imaging system according to the first embodiment of the present invention. As shown in FIG. 1, an electronic camera 10 in a room equipped with an illumination device 20 takes an image of an object 30 under illumination from the illumination device 20. The illumination device 20 includes a plurality of white LEDs as light emitters and illuminates the room in which the object 30 is present.

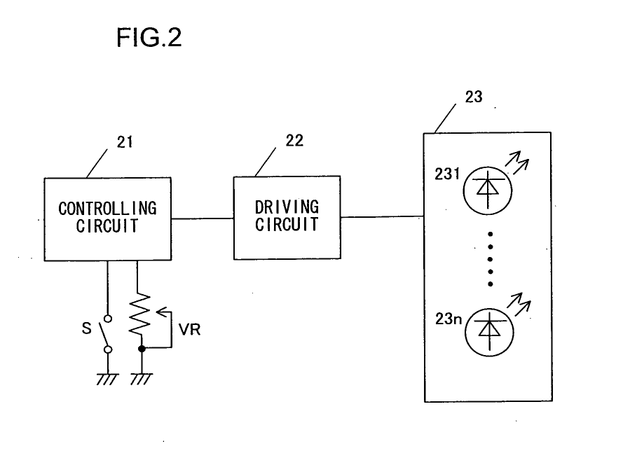

FIG. 2 is a block diagram illustrating the configuration of the illumination device 20. A white LED unit 23 emits light at a level depending on a current supplied from a driving circuit 22. In response to an instruction from a controlling circuit 21, the driving circuit 22 supplies driving current to n white LEDs 231 to 23n such that the sum of luminance attained by each of the n white LEDs 231 to 23n is equal to a predetermined luminance and at the same time performs amplitude modulation (intensity modulation) of the driving current supplied to each LED to superpose signals on the illumination light. Signals to be superposed include, for example, a signal indicative of luminance of the object 30 illuminated by the illumination device and a signal indicative of the color temperature of illumination light from the illumination device 20. The frequency of modulation is set to, for example, 50 Hz and a variation in luminance (flickering) due to the modulation is imperceptible to people.

When a lighting instruction signal is input to the controlling circuit 21 from a lighting switch S, the controlling circuit 21 instructs the driving circuit 22 to start supply of driving current of each of the white LEDs 231 to 23n, while the controlling circuit 21 instructs the driving circuit 22 to terminate supply of the driving current to each of the white LEDs 231 to 23n when an extinction signal is input to the controlling circuit 21 from the lighting switch S. Further, the controlling circuit 21 transmits a signal to the driving circuit 22, the signal instructing the driving circuit 22 to adjust driving current to be supplied to each of the white LED 231 to 23n in response to a control signal input from a light adjustment operation member VR. The controlling circuit 21 has already stored therein data showing a relationship between an operation amount of the light adjustment operation member VR and LED's luminance at the object 30 and is configured to superpose a luminance signal that depends on the operation amount of the light adjustment operation member VR to the superposed signal.

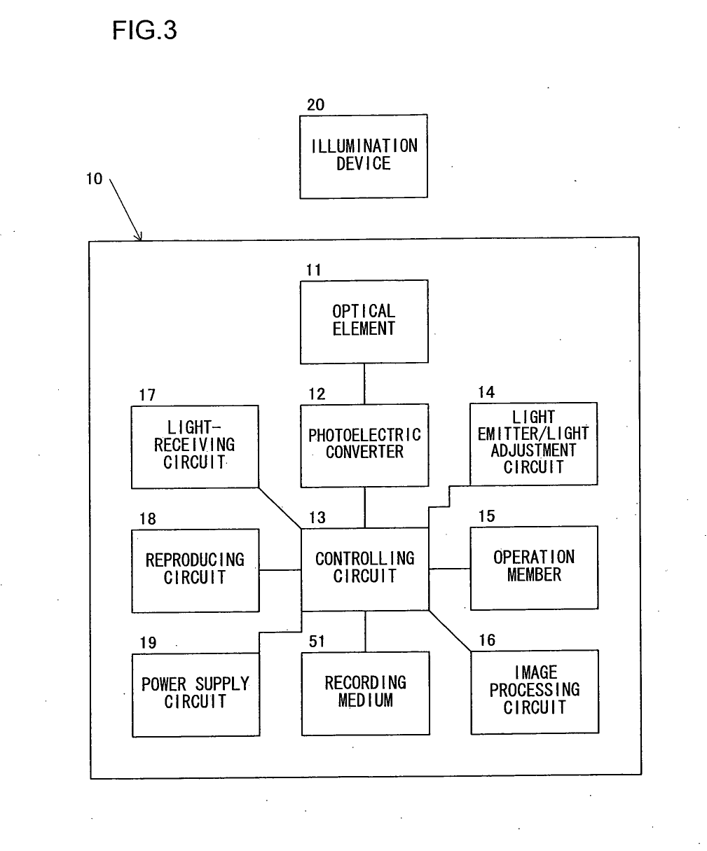

FIG. 3 is a block diagram illustrating the configuration of the electronic camera 10. In FIG. 3, the electronic camera 10 includes an optical element 11 constituted by a photographic lens (not shown), a photoelectric converter (imaging device) 12 including an image sensor (not shown), a controlling circuit 13, a light emitter/light adjustment circuit 14, an operation member 15, an image processing circuit 16, a light-receiving circuit 17, a reproducing circuit 18, and a power supply circuit 19.

The optical element 11 forms an image of the object 30 on an imaging surface of the image sensor (not shown). The photoelectric converter 12 captures an image of the object formed on the imaging surface and outputs imaging signals obtained from each pixel. The imaging signal output from the image sensor has a signal level, which varies depending on the intensity of light entering into each pixel. The photoelectric converter 12 converts the imaging signal output from the image sensor into a digital signal and send the converted data to the controlling circuit 13.

The controlling circuit 13 sends an instruction to the image processing circuit 16 to perform compression by a predetermined method (for example, JPEG) on the digital image data input from the photoelectric converter 12. The image processing circuit 16 performs image processing in response to the instruction and sends compressed image data to the controlling circuit 13. The image processing circuit 16 is configured to perform white balance adjustment (color adjustment) processing and edge enhancement processing as well as image compression processing.

The electronic image data after image compression is stored in a recording medium 51 by the controlling circuit 13. The recording medium 51 includes, for example, a data storage element such as a memory card.

The reproduction circuit 18 performs expansion processing upon expanding the compressed image data stored in the storing medium 51. The reproduced data after the expansion processing is output to, for example, an external monitor (not shown).

Various control signals are input to the controlling circuit 13 via the operation member 15. The controlling circuit 13 performs change of the contents of setting of the electronic camera 10 and imaging control in response to operation signals input via the operation member 15. Setting of the shutter speed is achieved in the photoelectric converter 12 in response to the instruction from the controlling circuit 13 while setting of the aperture value is achieved in the optical element 11 in response to the instruction from the controlling circuit 13.

The light emitter/light adjustment circuit 14 generates a flash upon imaging in response to the instruction from the controlling circuit 13 to illuminate the object 30. The light quantity at the time of flash lighting is determined by the light emitter/light adjustment circuit 14 based on the reflected light quantity at the time of pre-lighting.

The power supply circuit 19 includes, for example, a DC/DC converter circuit and voltage of a battery (not shown) is converted to a direct current voltage required in each block of the electronic camera 10 and the voltage after conversion is supplied to each block.

The light-receiving circuit 17 includes a light-receiving element (not shown) and a filter circuit (not shown). The light-receiving element receives illumination light from the illumination device 20 and converts the received light into electric signals depending on the received light quantity. The filter circuit (not shown) extracts a component having a predetermined frequency (for example, 50-Hz band) from the electric signals after conversion. The light-receiving circuit 17 demodulates the signals that have passed the filter and sends the demodulated signals to the controlling circuit 13.

The electronic camera 10 according to the present invention has an imaging mode in which controlled exposure is determined based on the signals superposed on the illumination light (hereafter, referred to as illumination light demodulation mode). When the electronic camera 10 is set in the illumination light demodulation mode, the controlling circuit 13 prohibits lighting by the light emitter/light adjustment circuit 14 and determines the aperture value and the shutter speed depending on the demodulated signals output from the light-receiving circuit 17 and imaging sensitivity (ISO value) set in the electronic camera 10. Setting into an illumination light demodulation mode and setting of imaging sensitivity are achieved based on control signals input via the operation member 15.

When the demodulated signal contains information indicative of luminance at the object 30, the controlling circuit 13 determines the aperture value and the shutter speed by performing conventional calculation of exposure using the luminance indicated by the demodulated signal and the imaging sensitivity (ISO value) set in the electronic camera 10. The controlling circuit 13 is configured to set a shutter speed that is shower (for example, 1/30 second) that the emitting frequency (in this case, 50 Hz) of the illumination device 20.

Further, when the demodulated signal contains information indicative of the color temperature of the illumination light, the controlling circuit 13 sends an instruction to the image processing circuit 16 to perform color adjustment based on a color temperature adjustment reference suitable to the color temperature indicated by the demodulated signal. For instance, when the color temperature is 5,500 K, the color adjustment is performed based on the color temperature adjustment reference that corresponds to daytime sunlight. When the color temperature is 4,500 K, the color adjustment is performed based on the color temperature adjustment reference that corresponds to cloudy weather. When the color temperature is 3,200 K, the color adjustment is performed based on the color temperature adjustment reference that corresponds to a lamp bulb. It is to be noted that actual color temperatures of illumination light from white LEDs 231 to 23n have been measured in advance and the controlling circuit 21 of the illumination device 20 is configured to include the signal indicative of the color temperature of the white LEDs in the superposed signal.

According to the first embodiment explained above, the following operational effects can be obtained.

(1) The illumination device 20 is adapted to perform illumination light communication and signals indicative of the luminance of the object 30 illuminated by the illumination light and color temperature of illumination light are superposed on the illumination light, so that the information can be directly transmitted from the illumination device 20 to the electronic camera 10.
(2) The electronic camera 10 is adapted to demodulate the illumination light received by the light-receiving circuit 17 and the aperture value and shutter speed are determined depending on the luminance information contained in the demodulated signal and the imaging sensitivity (ISO value) set in the electronic camera 10, so that appropriate exposure can be automatically obtained without exposure setting operations to the electronic camera 10 by the photographer.
(3) The electronic camera 10 is adapted to demodulate the illumination light received by the light-receiving circuit 17 and the color temperature adjustment reference at the time of color adjustment processing is changed depending on the information on the color temperature contained in the demodulated signal, so that appropriate color adjustment can be automatically performed without color adjustment setting operations to the electronic camera 10 by the photographer.
(4) The illumination device 20 is adapted to superpose a luminance signal depending on the operation amount of the light adjustment operation member VR on the illumination light, so that a change in luminance by the white LED 23 (information on the amount of light adjustment) can be transmitted in real-time from the illumination device 20 to the electronic camera 10.

While the information used by the electronic camera 10 for setting (changing) the color temperature adjustment reference and the information used by the electronic camera 10 for determining controlled exposure are included in the signals superposed on the illumination light from the illumination device 20 as the information used for changing photographic or imaging conditions for the electronic camera 10, the superposed signal may be configured to include only one of the types of information.

In addition, besides the information described above, information for setting a predetermined imaging scene mode in the electronic camera 10 or information for switching inhibition/allowance of flash lighting at the time of photography or imaging by the light emitter/light adjustment circuit 14 may be included in the information for changing the imaging conditions for the electronic camera 10.

The degree of modulation of illumination light by the illumination device 20 may be either 100% luminance blinking or a degree of modulation of less than 100%.

When the image sensor of the photoelectric converter 12 is not an image sensor of the charge accumulating type but one that allows monitoring of a change in quantity of light received, the photoelectric converter 12 may be configured to produce demodulated signals. On this occasion, the light-receiving circuit 17 in FIG. 3 may be omitted.

A laser light source may be used as the light emitter of the illumination device 20. For instance, red-themed illumination may be performed by using a helium-neon laser light source while blue-themed illumination may be used by using an argon laser light source. On this occasion, a conventional external modulator may be used in combination for modulating the illumination light.

### Second Embodiment

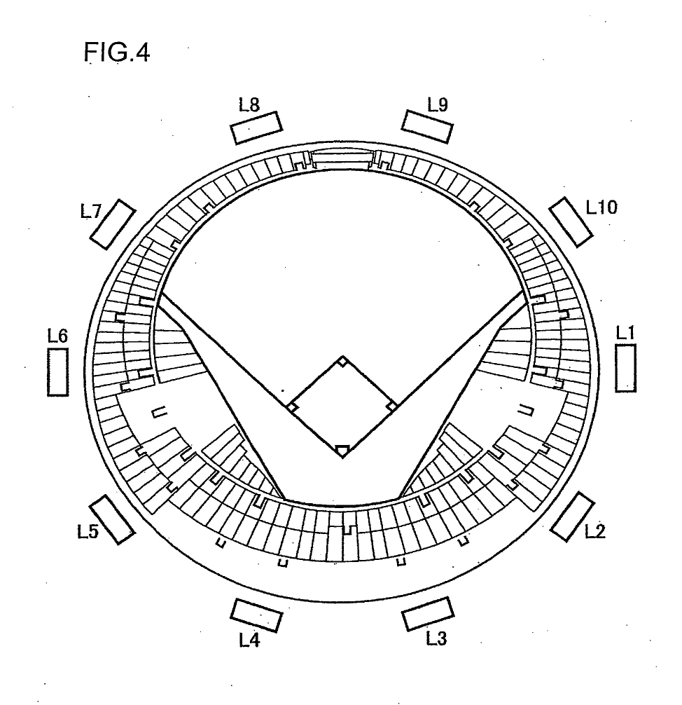

FIG. 4 is a diagram explaining the illumination device according to a second embodiment of the present invention. In FIG. 4, ten (10) illuminators L1 to L10 are installed in an arena. Each of the illuminators L1 to L10 includes a plurality of high-luminance LEDs.

A photographer in the auditorium takes an image of the field by means of the electronic camera 10. The illumination light from the illuminators L1 to L10 is superposed with signals indicative of the progress of a game as information for explaining the imaging scene. For instance, when the game being held is baseball, the information for explaining the imaging scene includes signals indicative of, for example, score, number of innings, top/bottom, strike count, ball count, and out count. In this case, the illuminators L1 to L10 superposes signals on the illumination light using display information (signals for displaying progress of the game) supplied from an external device (not shown) to a score board (not shown).

When the game being held is soccer, the information for explaining the imaging scene includes signals indicative of, for example, score, first half/second half, and lapsed time.

If the modulated signals contain those signals indicative of the progress of the game, the controlling circuit 13 of the electronic camera 10 stores the contents of the modulation signals as contained in Exif information when storing the photographed images in the recording medium 51.

According to the second embodiment as explained above, the following operational effects can be obtained.

(1) The illuminators L1 to L10 are adapted to perform illumination light communication and the signals indicative of the progress of the game being held in the arena are superposed on the illumination light, so that the signals from the illuminators can be directly received by the electronic camera 10 regardless of where the electronic camera 10 is in the auditorium.
(2) The electronic camera 10 is adapted to demodulate the illumination light received by the light-receiving circuit 17 and the contents of the signals indicative of the progress of the game contained in the demodulated signals is stored as contained in the Exif information when storing the photographed images in the recording medium 51, so that the progress of the game can be saved automatically without operations by the photographer to record voice memorandum.
(3) The illuminators L1 to L10 are adapted to superpose signals supplied from an external device (not shown) to the scoreboard on the illumination light, so that the signals indicative of the progress of the game can be transmitted in real-time from the illuminators L1 to L10 to the electronic camera 10.

Signals indicative of information on the facilities may be superposed on the illumination light from the illuminators L1 to L10 as information for explaining the imaging scenes. The information on facilities includes, for example, name of an arena and name of an amusement park.

In the first embodiment, the signals to be superposed on the illumination light include information for changing imaging conditions for the electronic camera 10 while in the second embodiment, the signals to be superposed on the illumination light include information for explaining scenes shot by the electronic camera 10. Also, the present invention may be configured such that both the information for changing imaging conditions and the information for explaining the imaging scenes are included in the signals to be superposed on the illumination light by combining the first and second embodiments.

While explanation has been made on a still camera as the electronic camera 10, the present invention may also be applied to a video camera and further the electronic camera 10 may be replaced by an electronic device with an electronic camera.

In addition, the present invention may be applied to a film camera instead of the electronic camera and the information for changing imaging conditions may be received via the illumination light.

While various embodiments and variations thereof have been explained above, the present invention should not be considered to be limited thereto and other embodiments conceivable within the technical concept of the present invention also fall within the scope of the present invention.

The content of disclosure of the following application to which priority is claimed in the present application is incorporated herein by reference:

Japanese Patent Application No. 2005-88213 (filed Mar. 25, 2005).

1. An imaging system comprising:
an imaging device; and
an illumination device independent of the imaging device, wherein:
the illumination device comprising;
a light emitter that emits illumination light, the light emitter including a plurality of light emitting diodes (LEDs);
a driving circuit that supplies driving current to the LEDs so that a sum of luminance attained by the LEDs is equal to a predetermined luminance and performs amplitude modulation of the driving current supplied to each of the LEDs to superpose a signal on the illumination light to generate modulated illumination light;
a modulating unit that causes the light emitter to emit the modulated illumination light; and
a modulation controlling unit that controls the modulating unit to superpose on the illumination light emitted from the light emitter the signal, including luminance information of an object illuminated with the illumination light and color temperature information of the illumination light, to be used to change imaging conditions in the imaging device that captures an image of the object illuminated with the illumination light; and
the imaging device comprising:
a light-receiving element that receives the illumination light on which the signal, including the luminance information of the object and the color temperature information of the illumination light, is superposed, with the illumination light used to illuminate the object for imaging;
a demodulating unit that demodulates a light signal received at the light-receiving element;
an imaging condition changing unit that changes an imaging condition in order to perform shooting under illumination of the illumination light, using the luminance information and the color temperature information contained in the light signal demodulated by the demodulating unit; and
an imaging unit that performs imaging under the imaging condition thus changed, wherein:
the imaging condition changing unit determines as the imaging condition an aperture value, a shutter speed and a color temperature adjustment reference to be used in color adjustment based on an imaging sensitivity set in the imaging device, the luminance information and the color temperature information contained in the light signal demodulated by the demodulating unit when the illumination light on which the signal is superposed is received by the light-receiving element.
